(19) United States
(12) Patent Application Publication
(10) Pub. No.: US 2015/0322981 A1
(43) Pub. Date: Nov. 12, 2015

(54) U-BOLT ASSEMBLY

(71) Applicant: Clamps Inc., Toledo, OH (US)

(72) Inventors: James Hudson, III, Toledo, OH (US); Tom B. Shackelford, Maumme, OH (US)

(21) Appl. No.: 14/319,119

(22) Filed: Jun. 30, 2014

Related U.S. Application Data
(63) Continuation of application No. 29/489,995, filed on May 6, 2014.

(51) Int. Cl. F16B 2/06; B21J 5/12; B21K 1/54

(52) U.S. Cl. CPC F16B 2/065; B21K 1/54; B21J 5/12

(57) ABSTRACT

A u-bolt assembly is provided. The u-bolt assembly includes opposing legs connected together by a connector portion. The connector portion has an interior surface. The interior surface has a plurality of surface structures. The surface structures are configured to engage and grip surfaces in contact with the connector portion. A cross member is configured to slidably engage the legs of the u-bolt. A plurality of fasteners is configured to engage the legs of the u-bolt such as to urge the cross member in a direction toward the connector portion of the u-bolt.

### RELATED APPLICATIONS

This application claims the benefit of pending U.S. Design application 29/489,995, filed May 6, 2014, the disclosure of which is incorporated herein by reference in its entirety.

### BACKGROUND

U-bolt assemblies can include a u-shaped bolt, a cross member and one or more fasteners. U-bolt assemblies are used in many applications, including for clamping one or more elements together, securing or supporting one or more elements, or sealing a connected region between two elements.

In typical applications, one or more fasteners are threaded onto a pair of threaded ends provided on the u-shaped bolt. As the fasteners are threaded onto the ends, they exert a force upon the cross member in the direction of a curved portion of the u-shaped bolt. The fasteners are threaded onto the threaded ends until they reach a desired point whereupon the cross member is located a desired distance from the curved portion of the u-shaped bolt. In this manner, the fasteners may be threaded so that the u-shaped bolt and the cross member cooperate to secure one or more elements located there between or clamp one or more elements located there between.

In certain non-limiting applications, such as for example, in the exhaust system of a vehicle, there are several exhaust conduits, tubes, hoses or pipes of various shapes and lengths which connect together to form a fluid path for the flow of exhaust gas. For these types of applications, typically the cross member is provided with a concave portion which opposes a corresponding concave curved portion on the u-shaped bolt. As the cross member and the u-shaped bolt are forced together towards each other through the use of the fasteners and the threaded ends of the u-shaped bolt, the corresponding concave portions cooperate to secure or clamp the elements there between.

U-shaped bolts can be formed and manufactured in a variety of methods. In certain methods, a straight rod having a constant circular cross-sectional shape and pre-threaded ends, is struck by a hammer having a circular cross-sectional shape. The hammer and an associated die form the u-shape of the u-shaped bolt. While this manufacturing method has been generally effective in forming u-shaped bolts, unfortunately it has been found that in certain instances slippage of the rod within the die can result in legs of the u-shaped bolt can have different lengths.

It would be advantageous if the methods used to manufacture u-shaped bolts could be improved.

### SUMMARY

The above objects, as well as other objects not specifically enumerated, are achieved by a u-bolt assembly. The u-bolt assembly includes opposing legs connected together by a connector portion. The connector portion has an interior surface. The interior surface has a plurality of surface structures. The surface structures are configured to engage and grip surfaces in contact with the connector portion. A cross member is configured to slidably engage the legs of the u-bolt. A plurality of fasteners is configured to engage the legs of the u-bolt such as to urge the cross member in a direction toward the connector portion of the u-bolt.

The above objects, as well as other objects not specifically enumerated, are achieved by a u-bolt. The u-bolt includes a plurality of opposing legs, each having a threaded end. A connector portion is configured to connect the opposing legs. The connector portion has an interior surface. The interior surface has a plurality of surface structures. The surface structures are configured to engage and grip surfaces in contact with the connector portion.

The above objects, as well as other objects not specifically enumerated, are achieved by a method of forming a u-bolt. The method includes the steps of positioning a u-bolt blank in an apparatus such that opposing ends of the u-bolt blank are supported and a center portion of the u-bolt blank is unsupported, contacting the unsupported portion of the u-bolt blank with a hammer such that the unsupported center portion is forced in a first direction, the hammer having a textured circumferential segment, forming surface structures on the unsupported center portion with the textured circumferential segment of the hammer, restraining substantial movement of the u-bolt blank in an “X” direction using the surface structures and allowing the plurality of opposing legs to rotate in a direction opposite the first direction thereby forming the opposing legs, the opposing legs have substantially equal lengths.

Various objects and advantages of the u-bolt assembly will become apparent to those skilled in the art from the following detailed description of the preferred embodiment, when read in light of the accompanying drawings

### BRIEF DESCRIPTION OF THE DRAWINGS

FIG. 1 is an exploded perspective view of a u-bolt assembly.

FIG. 2a is a front elevational view of a first embodiment of a connector portion of the u-bolt assembly of FIG. 1.

FIG. 2b is a side elevational view of the connector portion of FIG. 2a.

FIG. 3a is a front elevational view of a second embodiment of a connector portion of the u-bolt assembly of FIG. 1.

FIG. 3b is a side elevational view of the connector portion of FIG. 3a.

FIG. 4a is a front elevational view of a third embodiment of a connector portion of the u-bolt assembly of FIG. 1.

FIG. 4b is a side elevational view of the connector portion of FIG. 4a.

FIG. 5a is a front elevational view of a fourth embodiment of a connector portion of the u-bolt assembly of FIG. 1.

FIG. 5b is a side elevational view of the connector portion of FIG. 5a.

FIG. 6a is a front elevational view of a fifth embodiment of a connector portion of the u-bolt assembly of FIG. 1.

FIG. 6b is a side elevational view of the connector portion of FIG. 6a.

FIG. 7a is a front elevational view of a first embodiment of a connector portion of the u-bolt assembly of FIG. 1.

FIG. 7b is a side elevational view of the connector portion of FIG. 7a.

FIG. 8 is a schematic perspective view of apparatus configured to manufacture the u-bolt of the u-bolt assembly of FIG. 1 shown prior to a manufacturing operation.

FIG. 9 is a schematic perspective view of the apparatus of FIG. 8 shown during a manufacturing operation.

FIG. 10 is an expanded perspective view of a hammer used with the apparatus of FIG. 8 illustrating a textured circumferential segment.

### DETAILED DESCRIPTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

The description and figures disclose a u-bolt assembly for use in securing or clamping elements together. Generally, the u-bolt assembly forms opposing structures that are forced together to provide a clamping force for elements contained within the opposing structures. The clamping force not only forces the elements together but also maintains the elements in the clamped arrangement. The term “u-bolt”, as used herein, is defined to mean any structure having one or more legs and a connector portion arranged in a “u” cross-sectional shape. The term “cross member”, as used herein, is defined to mean any structure cooperating with the one or more legs of the u-bolt and opposing the connector portion of the u-bolt. The term “surface”, as used herein, is defined to mean the outer most face or exterior boundary of an associated structure.

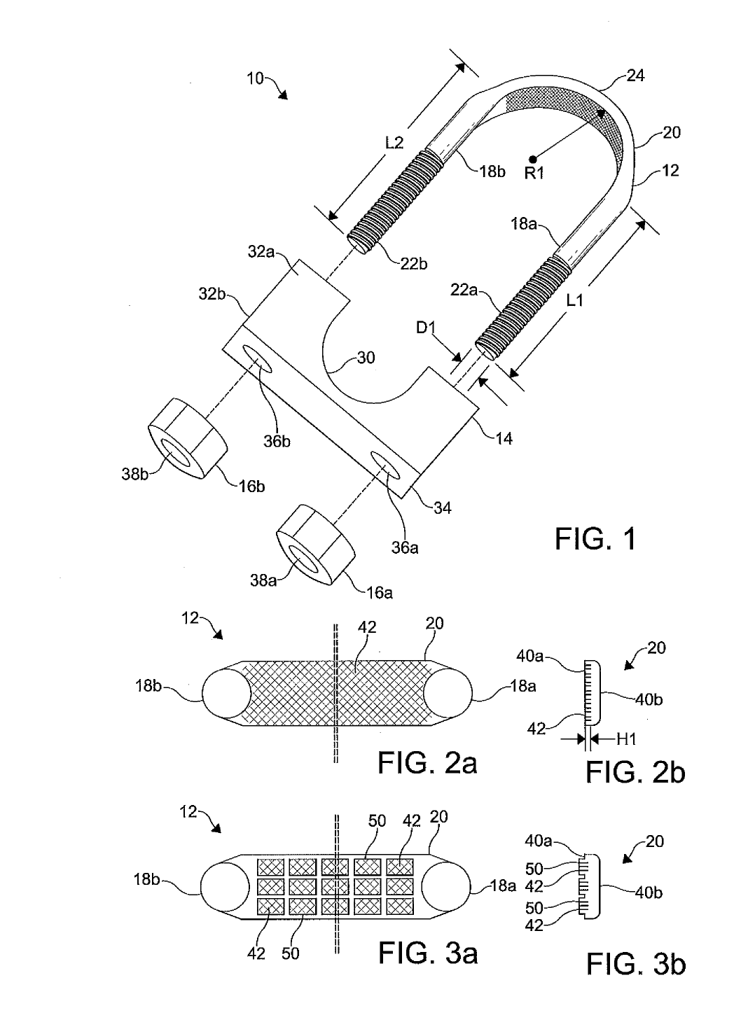

Referring now to the drawings, there is illustrated generally in FIG. 1 a u-bolt assembly (hereafter “assembly”) at 10. The assembly 10 includes a u-bolt 12, a cross member 14 and a plurality of fasteners 16a, 16b. The u-bolt 12, cross member 14 and plurality of fasteners 16a, 16b cooperate to clamp one or more elements together, secure or support one or more elements, or seal connected region between two elements.

Referring again to FIG. 1, the u-bolt 12 includes spaced apart, substantially parallel opposing legs 18a, 18b, extending outwardly from a connector portion 20. The legs 18a, 18b have threaded ends 22a, 22b configured to cooperate with the plurality of fasteners 16a, 16b.

Referring again to FIG. 1, the legs 18a, 18b have a generally circular cross-sectional shape. However, in other embodiments, the legs 18a, 18b can have other cross-sectional shapes sufficient to cooperate with the plurality of fasteners 16a, 16b. The legs 18a, 18b have a diameter D1. In the illustrated embodiment, the diameter D1 is in a range of from about 0.125 inches to about 0.750 inches. However, it should be appreciated that in other embodiments, the diameter D1 can be less than about 0.125 inches or more than about 0.750 inches.

Referring again to FIG. 1, the connector portion 20 forms a generally inwardly facing concave portion 24. The concave portion 24 forms a radius R1. In the illustrated embodiment, the radius R1 is in a range of from about 0.500 inches to about 9.000 inches. Alternatively, the radius R1 can be less than about 0.500 inches or more than about 9.000 inches.

While the embodiment of the connector portion 20 shown in FIG. 1 illustrates the concave portion 24, it should be appreciated that in other embodiments the connector portion 20 can be substantially straight. That is, it is contemplated that the connector portion 20 can be without a radius. The connector portion 20 will be discussed in more detail below.

Referring again to FIG. 1, the legs 18a, 18b have lengths L1, L2. In the illustrated embodiment, the lengths L1, L2 are substantially equal and in a range of from about 1.0 inches to 24.0 inches. In other embodiments, the lengths L1, L2 can be less than about 1.0 inch or more than about 24.0 inches. The lengths L1, L2 will be discussed in more detail below.

Referring again to FIG. 1, the cross member 14 is conventional in the art and will only be briefly described herein. The cross member 14 includes an inwardly facing concave portion 30 configured to oppose the concave portion 24 of the u-bolt. The cross member 14 also includes a pair of spaced apart and substantially parallel plates 32a, 32b connected together by a base plate 34. The base plate 34 extends transversely between base ends of the plates 32a, 32b. The base plate 34 includes base plate apertures 36a, 36b arranged and configured to receive the threaded ends 22a, 22b of the legs 18a, 18b when the u-bolt 12 is mounted to the cross member 14.

Referring again to FIG. 1, the u-bolt 12 and the cross member 14 are made from metallic materials, such as for example, 1018 carbon steel. In other embodiments, the u-bolt 12 and the cross member 14 can be made from other materials, including the non-limiting examples of 1541 stainless steel or aluminum.

The material forming the u-bolt 12 and the cross member 14 can have any desired surface finish, such as for example, a rust preventative type of galvanization.

Referring again to FIG. 1, the fasteners 16a, 16b have threaded apertures 38a, 38b configured to cooperate with the threaded ends 22a, 22b of the u-bolt 12. The threaded apertures 38a, 38b can have any desired thread pattern sufficient to cooperate with the threaded ends 22a, 22b.

Referring now to FIGS. 2a and 2b, the connector portion 20 of the u-bolt 12 is illustrated. Referring first to FIG. 2b, the connector portion 20 has the cross-sectional shape of a rounded rectangle. While the illustrated embodiment shows the connector portion 20 as a rounded rectangle, it is within the contemplation of the u-bolt 12 that the connector portion 20 can have other cross-sectional shape, such as the non-limiting example of a circular cross-sectional shape.

Referring again to FIG. 2b, the connector portion 20 has an interior surface 40a and an opposing exterior surface 40b. In the illustrated embodiment, the surfaces 40a, 40b are substantially parallel, although such is not necessary.

Referring again to FIGS. 2a and 2b, the interior surface 40a includes a plurality of surface structures 42. The term “surface structure”, as used herein, is defined to mean any structure or treatment located on or extending from a surface. As will be described in more detail below, the surface structures 42 are formed during the manufacture of the u-bolt 12 and are configured to provide several functions. First, the surface structures 42 are configured to facilitate the formation of the legs 18a, 18b such that the lengths L1, L2 are substantially. Second, the surface structures 42 are configured to minimize slippage of the u-bolt 12 during installation of the assembly 10.

Referring again to FIG. 2b, the surface structures 42 are configured to extend from the interior surface 40a of the connector portion 20 a height H1 such that the surface structures 42 can engage and grip other surfaces. In the illustrated embodiment, the height H1 is in a range of from about 0.010 inches to about 0.100 inches. In other embodiments, the height H1 can be less than about 0.010 inches or more than about 0.100 inches sufficient that the surface structures 42 can engage and grip other surfaces.

In the embodiment illustrated in FIGS. 2a and 2b, the surface structures 42 have the form of a knurled surface. The term “knurled surface”, as used herein, is defined to mean a series of intersecting cross hatchings forming raised ridges or projections. However, as will be discussed in more detail below, the surface structures 42 can have other forms.

Referring again to FIG. 2a, the surface structures 42 extend continuously across the interior surface 40a from one leg 18a to the opposing leg 18b. In other embodiments, the surface structures 42 can be any desired pattern of discontinuous segments and the surface structures 42 can extend any desired distance on the interior surface 40a.

One example of discontinuous segments of surface structures 42 is shown in FIGS. 3a and 3b. In this embodiment, a plurality of segments 50 is arranged in rows and columns on the interior surface 40a of the connector portion 20 with each of the segments 50 having the surface structures 42. The segments 50 can be arranged in any desired pattern and can have any desired surface structure.

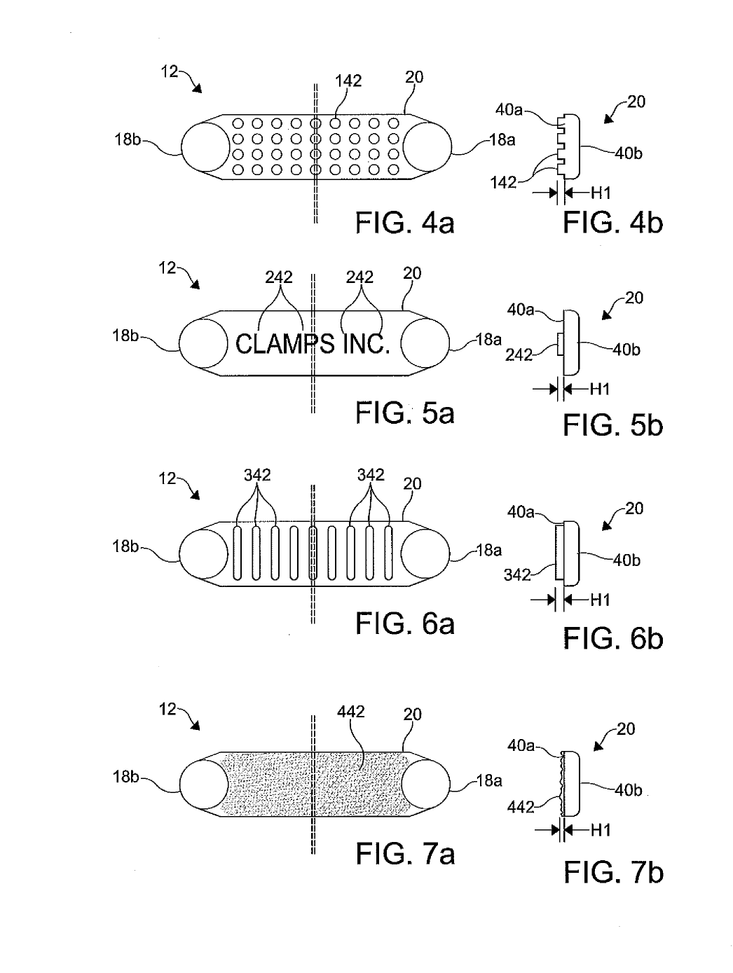

Referring again to FIGS. 2a and 2b, while the surface structures 42 have been described as a knurled surface, it should be appreciated that the surface structures 42 can have other forms, sufficient to allow the lengths L1, L2 of the legs 18a, 18b to be formed of substantially equal lengths during a manufacturing operation forming the u-shape of the u-bolt 12 and sufficient to minimize slippage of the u-bolt 12 during installation of the assembly 10. FIGS. 4a, 4b, 5a, 5b, 6a, 6b, 7a and 7b illustrate non-limiting examples of alternate surface structure forms. Components acting in an identical manner are denoted by the reference numbers used in FIGS. 1, 2a and 2b.

Referring now to FIGS. 4a and 4b, the connector portion 20 of the u-bolt 12 is illustrated. Referring first to FIG. 4b, the connector portion 20 has the cross-sectional shape of a rounded rectangle, an interior surface 40a and an opposing exterior surface 40b. The interior surface 40a includes a plurality of surface structures 142. In this embodiment, the surface structures 142 extend from the interior surface 40a and have the form of a plurality of nibs. The term “nib”, as used herein, is defined to mean any structure having a substantially protruding extremity.

The surface structures 142 have a height H1 and are arranged in rows and columns. However, the surface structures 142 can have other heights H1 and can be arranged in any desired pattern sufficient to allow the lengths L1, L2 of the legs 18a, 18b to be formed of substantially equal lengths during a manufacturing operation forming the u-shape of the u-bolt 12 and sufficient to minimize slippage of the u-bolt 12 during installation of the assembly 10.

In the embodiment illustrated in FIGS. 4a and 4b, the surface structures 142 have a circular cross-sectional shape and the rows and columns extend continuously across the interior surface 40a from one leg 18a to the opposing leg 18b, however any desired cross-sectional shape of the surface structures 142 can be used and the surface structures 142 can be arranged in discontinuous rows and column across any desired distance of the interior surface 40a.

While the surface structures 142 are shown as substantially identical “nibs”, it should be appreciated that the surface structures 142 can be different from each other.

It should be appreciated that the surface structures positioned on the interior surface of the connector portion can be arranged in novel fashions sufficient that the surface structures 42 can engage and grip other surfaces. Referring now to FIGS. 5a and 5b, the connector portion 20 of the u-bolt 12 is illustrated. Referring first to FIG. 5b, the connector portion 20 has an interior surface 40a and an opposing exterior surface 40b, The interior surface 40a includes a plurality of surface structures 242. In this embodiment, the surface structures 242 extend from the interior surface 40a and have the shape of alphabetical letters, numbers or other desired shapes. Optionally, the letters forming the surface structures 242 can form words, phrases, numbers or logos.

The surface structures 242 have a height H1 and are arranged in a single row. However, the surface structures 242 can have other heights and can be arranged in any desired pattern sufficient to allow the lengths L1, L2 of the legs 18a, 18b to be formed of substantially equal lengths during a manufacturing operation forming the u-shape of the u-bolt 12 and sufficient to minimize slippage of the u-bolt 12 during installation of the u-bolt assembly 10.

In the embodiment illustrated in FIGS. 5a and 5b, the surface structures 242 extend continuously across the interior surface 40a from one leg 18a to the opposing leg 18b, however the surface structures 242 can be arranged in any desired pattern or in a random arrangement across any desired distance of the interior surface 40a.

Referring now to FIGS. 6a and 6b, another embodiment of a surface structure is illustrated. Referring first to FIG. 6b, the connector portion 20 has an interior surface 40a and an opposing exterior surface 40b. The interior surface 40a includes a plurality of surface structures 342. In this embodiment, the surface structures 342 are formed as spaced apart ridges extend transversely across a width of the connector portion 20.

The surface structures 342 have a height H1 and are arranged in a single row. However, the surface structures 342 can have other heights and can be arranged in any desired pattern sufficient to allow the lengths L1, L2 of the legs 18a, 18b to be formed of substantially equal lengths during a bending operation forming the u-shape of the u-bolt 12 and sufficient to minimize slippage of the u-bolt 12 during installation of the u-bolt assembly 10.

In the embodiment illustrated in FIGS. 6a and 6b, the surface structures 342 extend continuously across the width of the connector portion 20 from one leg 18a to the opposing leg 18b, however the surface structures 342 can include discontinuous ridges arranged in any desired pattern or in a random arrangement across any desired distance of the interior surface 40a.

While the surface structures 42, 142, 242 and 342 are described above as structures formed integral to the connector portion of the u-bolt, it is within the contemplation of this invention that one or more surface structures can be applied to or attached to the connector portion of the u-bolt. Referring now to FIGS. 7a and 7b, one non-limiting example of an applied surface structure is illustrated. Referring first to FIG. 7b, the connector portion 20 has an interior surface 40a and an opposing exterior surface 40b. The interior surface 40a includes applied surface coating structures 442. In this embodiment, the surface structures 442 are included in an applied coating or layer of a substantially abrasive material, such as for example, an abrasive grit that extends from the interior surface 40a. Non-limiting examples of abrasive grit include silica, iron oxide, aluminum oxide or polymeric materials. The abrasive grit can be attached to the interior surface 40a in any desired manner, including, for example, adhesives or sonic welding.

The surface structures 442 have a height H1 and are arranged randomly across the interior surface 40a of the connector 20. However, the surface structures 442 can have other heights and can be arranged in any desired pattern sufficient to allow the lengths L1, L2 of the legs 18a, 18b to be formed of substantially equal lengths during a manufacturing operation forming the u-shape of the u-bolt 12 and sufficient to minimize slippage of the u-bolt 12 during installation of the u-bolt assembly 10.

In the embodiment illustrated in FIGS. 7a and 7b, the surface structures 442 extend continuously across the interior surface 40a from one leg 18a to the opposing leg 18b, however the surface structures 442 can be arranged in any desired pattern or in a random arrangement across any desired distance of the interior surface 40a.

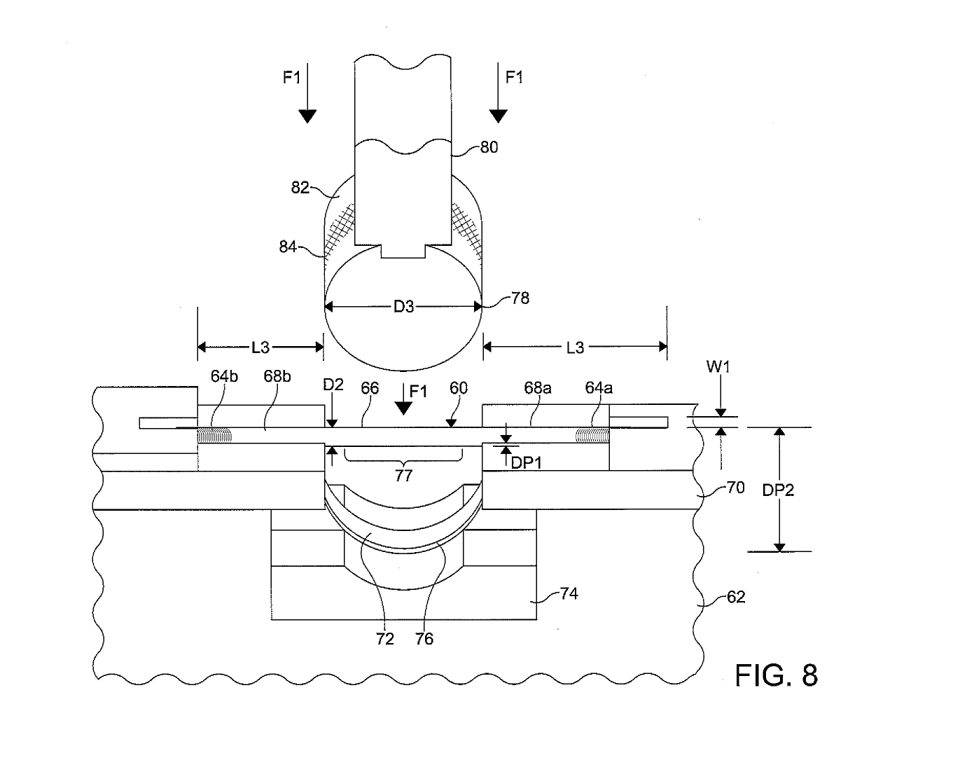

As discussed above, in certain instance the surface structures on the interior surface of the connector portion can be formed during the manufacture of the u-bolt. Referring now to FIGS. 8-10, the apparatus forming the u-bolt and the surface structures is schematically illustrated and will now be described. Referring first to FIG. 8, a u-bolt blank 60 is shown positioned in a die 62. The u-bolt blank 60 includes threaded ends 64a, 64b connected by a center portion 66. The center portion 66 has a circular cross-sectional shape and a diameter D2. The diameter D2 is the same as the diameter D1 shown in FIG. 1 and discussed above. As shown in FIG. 8, the u-bolt blank 60 is substantially straight from one threaded end 64a to the other threaded end 64b. That is, in the illustrated embodiment, there is no curvature in the center portion 66. However, it is contemplated that in other embodiments, the center portion 66 can have curvature.

Referring again to FIG. 8, the u-bolt blank 60 is positioned in opposing channels 68a, 68b formed in a framework 70 of the die 62. Each of the channels 68a, 68b has a length L3, width W1 and a depth DP1. The lengths L3 of the channels 68, 68b are configured such that the center portion 66 is unsupported in the framework 70. During a manufacturing operation, the length L3 of the opposing channels 68a, 68b is configured prevent substantial movement of the u-bolt blank 60 in an “X” direction, the width W1 is configured prevent substantial movement of the u-bolt blank 60 in a “Z” direction and the depth DP1 is configured allow substantial movement of the center portion of the u-bolt blank 60 in a “Y” direction.

Referring again to FIG. 8, the die 62 includes an anvil segment 72 supported by an base frame 74. The anvil segment 72 includes an interior surface 76 and forms a depth DP2. The anvil segment 72 will be discussed in more detail below.

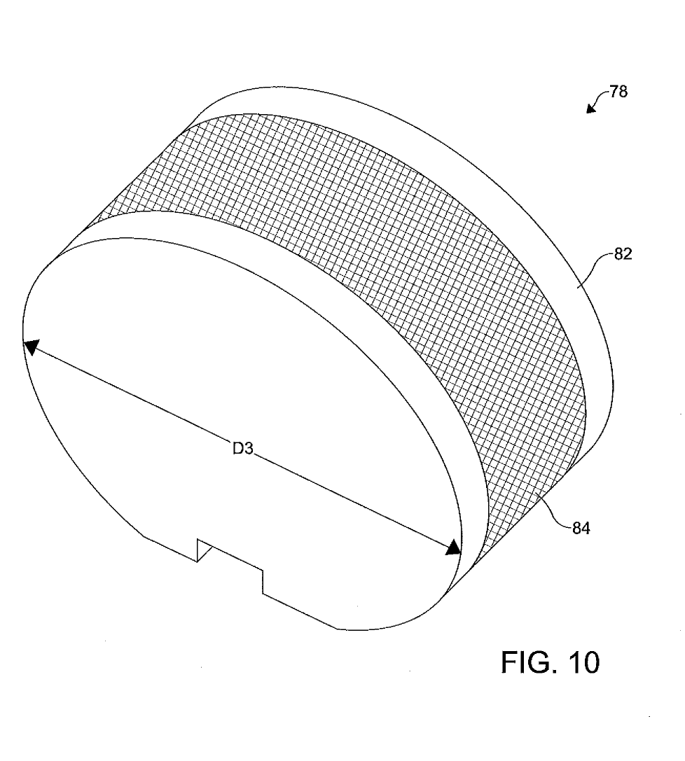

Referring now to FIGS. 8 and 10, a hammer 78 is connected to a ram 80. The hammer 78 is positioned above the center segment 77 of the u-bolt blank 60. The hammer 78 has a circular cross-sectional shape and a diameter D3. In operation, the circular cross-sectional shape of the hammer 78 is configured to form the concave portion 24 of the connector portion 20 of the u-bolt 12 as shown in FIG. 1 and described above. In the illustrated embodiment, the diameter D3 equates to the radius R1 and is in a range of from about 1.000 inch to about 18.000 inches. Alternatively, the diameter D3 can be less than about 1.000 inch or more than about 18.000 inches.

Referring again to FIGS. 8 and 10, the hammer 78 has a circumferential face 82. The face 82 has a textured circumferential segment 84. As will be explained in more detail below, the textured segment 84 of the hammer is configured to form the surface structure 42 shown in FIGS. 2a and 2b and described above.

Referring now to FIG. 8, the ram 80 is configured to force the hammer 78 into contact with the center segment 77 of the u-bolt blank 60 as illustrated by direction arrows F1. In the illustrated embodiment, the ram 80 is a hydraulic cylinder. However, in other embodiments, the ram 80 can be other desired structures or devices sufficient to urge the hammer 78 into contact with the u-bolt blank 60.

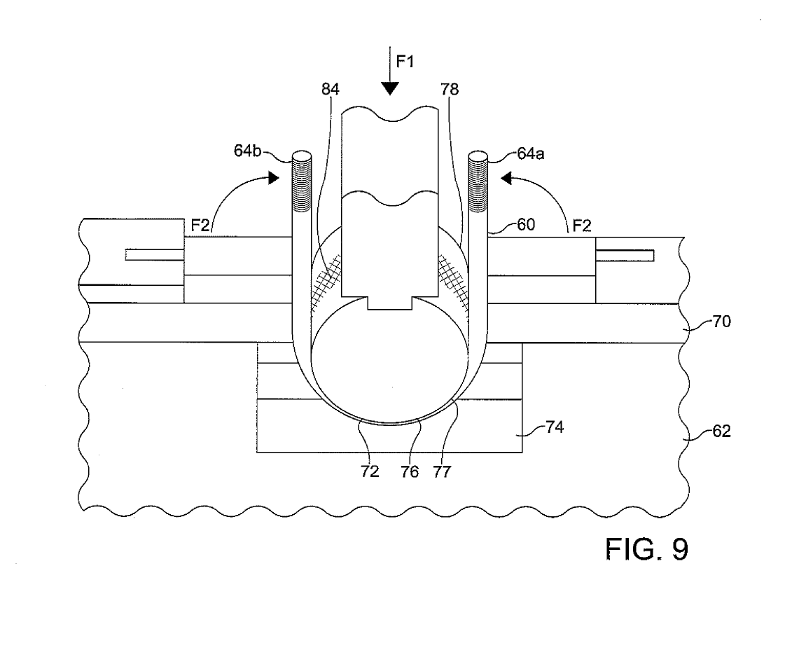

Referring now to FIG. 9, the hammer 78 is shown in an extended position in contact with the u-bolt blank 60. In the extended position, the hammer 78 forces the center segment 77 of the u-bolt blank 60 into contact with the interior surface 76 of the anvil segment 72 thereby providing several functions. First, as the hammer 78 moves downward against the center segment 77 of the u-bolt blank 60, the portions of the u-bolt blank 60 supported by the channels 68a, 68b are forced to rotate in an opposite direction as shown by direction arrows F2. In this manner, the legs 22a, 22b of the u-bolt 12 are simultaneously formed. Second, as the hammer 78 moves downward against the center segment 77 of the u-bolt blank 60, the center segment 77 forms the concave portion 24 of the connector portion 20 of the u-bolt. Third, as the hammer 78 moves downward against the center segment 77 of the u-bolt blank 60, the diameter D3 of the hammer forms the corresponding radius R1 of the concave portion 24 of the connector portion 20 of the u-bolt. Fourth, as the hammer 78 moves downward against the center segment 77 of the u-bolt blank 60, the hammer 78 provides sufficient force that the center segment 77 is “flattened” into the rounded rectangular cross-sectional shape of the connector segment 20 illustrated in FIG. 2b and described above. Finally, as the hammer 78 moves downward against the center segment 77 of the u-bolt blank 60, the textured circumferential segment 84 of the exterior face 82 of the hammer 78 imparts the surface structure 42 on the interior surface 24 of the connector portion 20.

It has been unexpectantly found that the interaction of the textured circumferential segment 84 and the imparted surface structure 42 on the interior surface 24 of the connector portion 20 of the u-bolt blank 60 during the manufacturing operation substantially prevents relative slippage between the u-bolt blank 60 and the hammer 78. Preventing slippage of the u-bolt blank 60 results in minimal movement of the u-bolt blank 60 in the “X” direction. Since movement of the u-bolt blank 60 in the “X” direction is substantially prevented, advantageously it is now possible the control the resulting lengths L1, L2 of the legs 22a, 22b to be substantial equal during the simultaneous formation of the legs 22a, 22b.

Referring again to FIG. 10, it has been described above that the textured circumferential segment 84 on the exterior face 82 of the hammer 78 forms the surface structure 42 on the interior surface 24 of the connector portion 20 of the u-bolt 12. In the illustrated embodiment, the textured circumferential segment 84 forms the knurled surface structure 42 shown in FIGS. 2a and 2b. However, it should be appreciated that the textured circumferential segment 84 can be configured to provide the various surface structures 142, 242, 342 and 442 illustrated in FIGS. 4a, 4b, 5a, 5b, 6a, 6b, 7a and 7b.

The principle and mode of operation of the u-bolt assembly has been described in its preferred embodiments. However, it should be noted that the u-bolt assembly may be practiced otherwise than as specifically illustrated and described without departing from its scope.

What is claimed is:

1. A u-bolt assembly comprising:
a u-bolt having opposing legs connected together by a connector portion, the connector portion having an interior surface, the interior surface having a plurality of surface structures, the surface structures configured to engage and grip surfaces in contact with the connector portion,
a cross member configured to slidably engage the legs of the u-bolt, and
a plurality of fasteners configured to engage the legs of the u-bolt such as to urge the cross member in a direction toward the connector portion of the u-bolt.

2. The u-bolt assembly of claim 1, wherein the connector portion has an inwardly facing concave portion.

3. The u-bolt assembly of claim 1, wherein the connector portion has a rounded rectangular cross-sectional shape.

4. The u-bolt assembly of claim 1, wherein the surface structures are knurled structures.

5. The u-bolt assembly of claim 1, wherein the surface structures extend continuously on the interior surface of the connector portion from one leg of the u-bolt to the opposing leg.

6. The u-bolt assembly of claim 1, wherein the surface structures are arranged in a pattern of rows and columns.

7. The u-bolt assembly of claim 1, wherein the surface structures have a height in a range of from about 0.010 inches to about 0.100 inches.

8. The u-bolt assembly of claim 1, wherein the surface structures form a layer on a surface of the interior surface of the connector portion.

9. A u-bolt comprising:
a plurality of opposing legs, each having a threaded end; and
a connector portion configured to connect the opposing legs, the connector portion having an interior surface, the interior surface having a plurality of surface structures, the surface structures configured to engage and grip surfaces in contact with the connector portion.

10. The u-bolt of claim 9, wherein the connector portion has an inwardly facing concave portion.

11. The u-bolt of claim 9, wherein the connector portion has a rounded rectangular cross-sectional shape.

12. The u-bolt of claim 9, wherein the surface structures are knurled structures.

13. The u-bolt of claim 9, wherein the surface structures extend continuously on the interior surface of the connector portion from one leg of the u-bolt to the opposing leg.

14. The u-bolt of claim 9, wherein the surface structures are arranged in a pattern of rows and columns.

15. The u-bolt of claim 9, wherein the surface structures form a layer on the interior surface of the connector portion.

16. A method of forming a u-bolt comprising the steps of:
positioning a u-bolt blank in an apparatus such that opposing ends of the u-bolt blank are supported and a center portion of the u-bolt blank is unsupported;
contacting the unsupported portion of the u-bolt blank with a hammer such that the unsupported center portion is forced in a first direction, the hammer having a textured circumferential segment;
forming surface structures on the unsupported center portion with the textured circumferential segment of the hammer;
restraining substantial movement of the u-bolt blank in an “X” direction using the surface structures; and
allowing the plurality of opposing legs to rotate in a direction opposite the first direction thereby forming the opposing legs, the opposing legs have substantially equal lengths.

17. The method of claim 16, including the step of forming a connector portion from the unsupported portion of the u-bolt blank, the connector portion having a rounded rectangular cross-sectional shape.

18. The method of claim 17, wherein the surface structures are formed on the connector portion.

19. The method of claim 16, wherein the surface structures are knurled structures.

20. The method of claim 16, wherein the surface structures extend continuously on the unsupported center portion of the u-bolt blank from one leg of the u-bolt to the opposing leg.
